(19) United States
(12) Patent Application Publication
(10) Pub. No.: US 2024/0376278 A1
(43) Pub. Date: Nov. 14, 2024

(54) EPOXY RESIN FORMULATIONS AND PROCESSES FOR PRODUCING AEROSPACE-GRADE COMPOSITES VIA LOW TEMPERATURE, ISOTHERMAL INFUSION

(71) Applicant: United States of America as represented by the Administrator of NASA, Washington, DC (US)

(72) Inventors: Joseph G. Smith, JR., Smithfield, VA (US); Scott R. Zavada, Williamsburg, VA (US); Elizabeth Moore, Richmond, VA (US); John M. Gardner, Newport News, VA (US); Godfrey Sauti, Yorktown, VA (US); Benjamin D. Jensen, Traverse City, MI (US); Keith L. Gordon, Hampton, VA (US); Emilie J. Siochi, Newport News, VA (US)

(21) Appl. No.: 18/653,488

(22) Filed: May 2, 2024

Related U.S. Application Data
(60) Provisional application No. 63/465,095, filed on May 9, 2023.

(51) Int. Cl. C08J 5/24

(52) U.S. Cl. CPC C08J 5/24; C08J 2363/00

(57) ABSTRACT

Epoxy resin formulations and processes for producing composites via low temperature, isothermal infusion, the composites exhibiting performance characteristics suitable for aerospace materials and applications thereof, the formulations comprising: Type-1 anionic formulations; Type-2 anionic formulations; Type-2 anionic formulations with toughener; and cationic formulations. The composites include an epoxy resin formulation and one or more composite fiber materials, the composites formed via an isothermal infusion and cure process in which infusion and cure temperatures of the epoxy resin are about the same, are less than about 100° C., and cure time is less than about one hour. The composites have a glass transition temperature (T_{g})≥150° C. and a storage modulus ≥3 GPa.

### CROSS-REFERENCE TO RELATED APPLICATIONS

This patent application claims the benefit of and priority to U.S. Provisional Application Ser. No. 63/465,095 filed on May 9, 2023, the contents of which are hereby incorporated by reference in their entirety.

### FEDERALLY SPONSORED RESEARCH AND DEVELOPMENT

The invention described herein was made in performance of work under a NASA contract and by an employee/employees of the United States Government and is subject to the provisions of Public Law 96-517 (35 U.S.C. § 202) and may be manufactured and used by or for the Government for governmental purposes without the payment of any royalties thereon or therefore. In accordance with 35 U.S.C. § 202, the contractor elected not to retain title.

### FIELD OF THE INVENTION

The invention described herein relates generally to aerospace-grade resins and fiber-reinforced composites constructed therefrom. More specifically, it relates to epoxy resin formulations that cure in less than one hour and processes for producing fiber-reinforced composites exhibiting characteristics necessary for high-performance, aerospace materials via low temperature, and isothermal infusion.

### BACKGROUND OF THE INVENTION

Aerospace grade resins are a type of high-performance resin used in the construction of aircraft and spacecraft. They are specially formulated to meet the demanding requirements of the aerospace industry, which include high strength and stiffness, low weight, fire resistance, temperature resistance, and chemical resistance.

There are several different types of aerospace grade resins, including epoxies, polyimides, and bismaleimides (BMI), to name a few. Of these, epoxies are a common type of aerospace grade resin as they are generally strong, stiff, and lightweight.

Given these desirable properties, epoxies are widely used to manufacture fiber-reinforced composite materials that include reinforcing fibers and epoxy (matrix) resins. Such fiber-reinforced composites are oftentimes produced by infusion techniques in which a pressure differential is employed to infuse the resin into the reinforcing fibers, producing an infusion composite.

The infusion composite is typically made of a dry fabric reinforcement placed inside a mold cavity. A pressure differential is established between a neat resin source and the mold. This forces the resin into the mold cavity and dry fabric where it flows throughout the fabric, saturating the reinforcing fibers. The resin is then cured, and the infusion composite is removed from the mold.

Contemporary aerospace grade epoxy resins generally require infusion at temperatures much lower than cure temperatures to achieve infusion before initiation of cure. Cure cycles typically involve subsequently raising temperatures to more than 150° C., with multiple hour holds which results in delays in achieving completed parts. Additionally, tooling/toolsets—including molds—may require numerous heating/cooling cycles to load and process the multiple infusion composite parts. As a result, total infusion and cure times may require many hours, limiting the number of infusion composite parts that can be produced with a given toolset in a period of time.

In view of these deficiencies, improved resin formulations and infusion methods that more quickly produce high-performance, aerospace-grade composites would be a welcome addition to the art.

### SUMMARY OF THE INVENTION

An advance in the art is made according to aspects of the present invention which, in its broadest aspects, provides rapid curable resin formulations and aerospace-grade composites via isothermal infusion routes at low temperatures in which the infusion and cure temperatures of the epoxy resin are substantially the same.

In sharp contrast to the prior art and according to the present invention it has surprisingly turned out that epoxy resin formulations can be infused and cured isothermally at temperatures below 100° C. within an hour, and subsequent to a post cure, yield composite parts exhibiting aerospace performance characteristics.

Viewed from a first aspect, the present invention provides rapid curable resin formulations that permit relatively low temperature isothermal infusion and cure while still yielding aerospace-grade performance. According to aspects of the present invention, infusion and initial cure can be completed quickly and—in further contrast to the prior art—a partially cured infusion composite may be removed from a hot infusion tooling (i.e., mold, etc.) without deforming. A subsequent free-standing post cure outside of the infusion tooling can then be performed while maintaining structural integrity to achieve optimal aerospace-grade performance properties, thereby allowing the hot infusion tooling to be used to form another infusion composite part without undergoing a cooling/heating cycle.

According to additional aspects of the present invention, and in still further contrast to the prior art, temperature of resin infusion and initial, in-mold cure are far lower than prior-art temperatures used during the preparation of aerospace-grade composites. Such lower temperatures permit full and complete resin infusion of reinforcement fabric during composite fabrication and enable the use of lower cost tooling materials, further reducing manufacturing cost.

Further aspects of the present invention relate to resin formulations that are infusible at the same temperature as the cure temperature (i.e., isothermal). In one embodiment, a resin composition can be both infused and cured at temperatures below 100° C. In another embodiment, the resin composition can be infused and cured at temperatures between 90° C. and 100° C. In further embodiments, the infusing temperature may be within 5° C. of the curing temperature and both infusion and curing temperatures are below 100° C. In yet further embodiments, both the resin infusion and cure temperatures are between 80° C. and 100° C., while still yielding composite components (e.g., panels) that do not deform upon removal from tooling at cure temperature.

Further embodiments may exhibit a low cure temperature for the duration of the cure—which is less than or equal to an hour—while still yielding a non-deformable composite part for aerospace structural components that exhibit aerospace performance characteristics.

Yet further embodiments relate to a resin formulation that can be both infused and cured at a temperature below 100° C. within one hour to yield composite parts with aerospace performance characteristics.

Viewed from a manufacturing aspect, our inventive isothermal rapid cure resins may facilitate the fabrication of multiple composite components over a given period, such as per day, using fewer toolsets per day as compared with prior art methods.

In certain implementations, one or more methods are used to manufacture a carbon fiber composite from one or more of our inventive isothermal rapid cure resin formulations.

Still further aspects of the present invention relate to processing and post-processing cycles for isothermal resins to yield aerospace grade composites that are advantageously controlled to avoid thermal runaway—a process that is characterized by increased temperature, in turn releasing energy that further increases temperature.

Further embodiments provide a process with an infusion and cure ΔT of 10° C., but more preferably 5° C., and even more preferably 0° C.

Further aspects relate to a process having both infusion and cure completed within an hour when the composite part can be removed from the hot tool without deforming for continued post processing to achieve aerospace performance based on glass transition temperatures ≥150° C. and mechanical properties (high modulus (e.g. storage modulus ≥3 GPa)—inelastic or stiff, strength and toughness).

In one illustrative embodiment, a composite part may be removed from a hot tool, in which the composite part is flat. In one such example, a 6″ (150 mm)×6″ (150 mm) panel having a thickness ranging from 0.09″ (2.25 mm)-0.18″ (4.5 mm) may be produced from one or more methodologies provided herein. In one such example, to assure that the part does not creep/deform during post cure, the post cure may include the use of about 0.83 kg to 3.3 kg weight set on the panel, such as for example, around the center of the 6″ (150 mm)×6″ (150 mm) panel. In some examples, 0.83 kg was successfully used for the thinner panels, while weights of 2.6 kg or 3.3 kg were used for thicker panels. These evaluations confirmed—in further contrast to the prior art aerospace resins—that the respective panels remained flat with no physical deflection of more than ±0.002″ (+0.05 mm) when depressed in the center of the panel as it was positioned on a polished metal plate having flatness tolerances of ±0.002″ (0.05 mm).

With the benefit of this invention disclosure, those skilled in the art will appreciate that several resin formulations that are disclosed and in accordance with a classification scheme, may be classified into four (4) general types-three (3) of which are based on anionic polymerization and one (1) based on cationic polymerization. The novel resin formulations are prepared from commercially available components, thereby lowering the difficulty in obtaining the materials needed, and in some instances, greatly reducing the costs of materials when compared to specialty components that are not as readily available.

The example structures and compositions are included within this document, along with available rheology, glass transition temperatures and mechanical properties are intended to demonstrate the breadth of applicability, however, and are not to be interpreted as limiting examples.

### BRIEF DESCRIPTION OF THE DRAWINGS

A more complete understanding of the present invention may be realized by reference to the accompanying drawing in which:

FIG. 1 is a plot of Temperature (° C.) vs Time (min) vs Pressure (bar) for contemporary benchmark thermoset resin (HiFlow® 1078-1) for aerospace applications;

FIG. 2 is a plot of Temperature (° C.) vs Time (min) vs Pressure (bar) for isothermal rapid cure resins for aerospace applications according to aspects of the present invention;

FIG. 3 is a schematic diagram showing an illustrative arrangement for composite processing according to aspects of the present invention;

Illustrative embodiments are described more fully by the Figures and detailed description. The inventions may, however, be embodied in various forms and are not limited to specific embodiments described in the Figures and detailed description.

### DETAILED DESCRIPTION OF THE INVENTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are intended to be only for pedagogical purposes to aid the reader in understanding the principles of the invention and the concepts contributed by the inventor(s) to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any components developed that perform the same function, regardless of structure.

Thus, for example, it will be appreciated by those skilled in the art that any block diagrams herein represent conceptual views of illustrative structures embodying the principles of the disclosure.

Unless otherwise explicitly specified herein, the FIGs comprising the drawing are not drawn to scale.

By way of some additional background, we again note advantageous aspects of compositions and methods according to the present invention that provide infusion and curing occurring at the same temperature thereby eliminating numerous heating/cooling cycles that substantially reduces total composite part fabrication time while still producing a composite part exhibiting the necessary aerospace-grade performance characteristics.

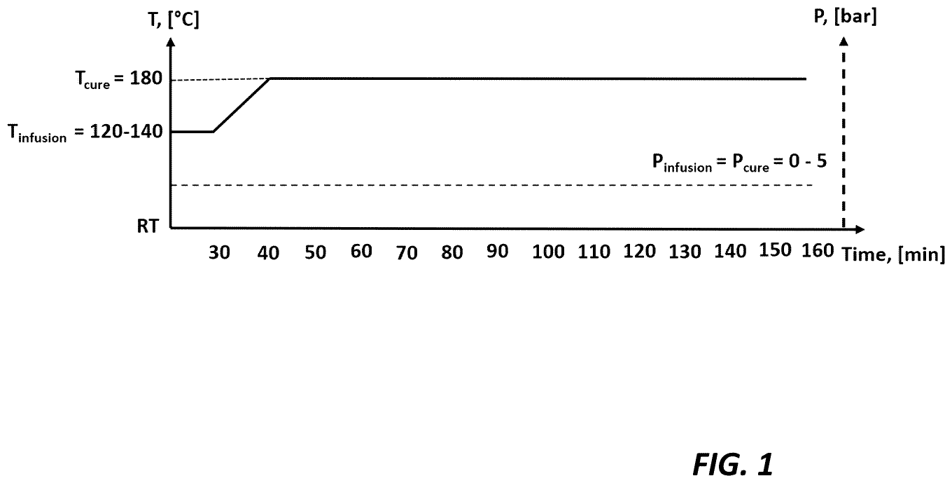

Similarly, FIG. 1 is a plot of Temperature (C) vs Time (min) vs Pressure (bar) for a benchmark thermoset resin for aerospace applications namely, HiFlow® 1078-1 (Hexcel Corporation). With reference to that FIG. 1, it may be observed that a contemporary, state-of-the-art thermoset resin for aerospace applications will illustratively be infused for 30 minutes at a T_{infusion} temperature of 120° C. to 140° C. and cured for 120 minutes at a T_{cure} temperature of 180° C. while maintaining a constant pressure for a total preparation time of 160 minutes.

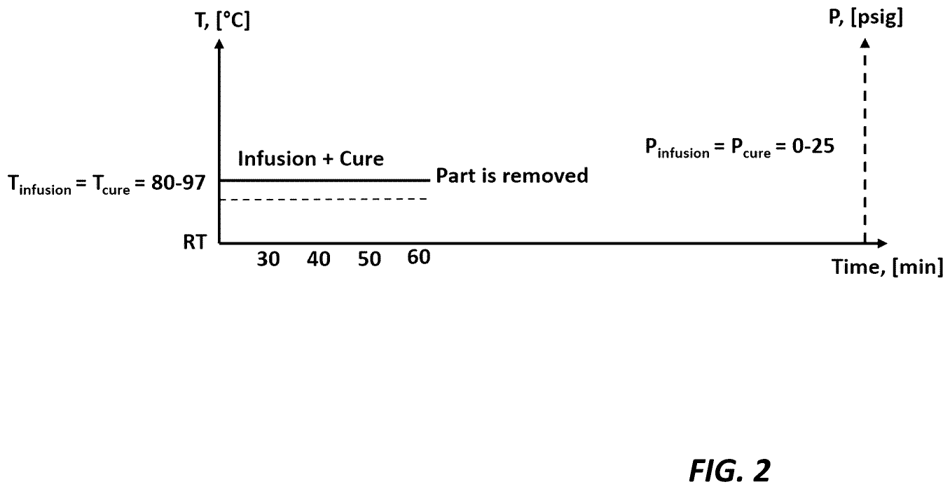

As an illustrative contrast, FIG. 2 is a plot of Temperature (° C.) vs Time (min) vs Pressure (bar) for isothermal rapid cure resins for aerospace applications according to aspects of the present invention. With reference to that FIG. 2, it may be observed that an exemplary isothermal rapid curing resin for aerospace applications according to aspects of the present invention will illustratively be infused and cured at a common T_{infusion}=T_{cure} temperature of 83° C. to 85° C. for a total time of 60 minutes, thereby eliminating the elevated cure temperature and 100 minutes of total preparation time.

As those skilled in the art will readily appreciate, our inventive isothermal rapid cure resins for aerospace applications substantially reduces the temperatures, cure times, and overall preparation time as compared to several state-of-the-art, aerospace-grade commercial resins. Summary comparisons of infusion temperature (° C.), cure temperature (° C.), and cure time (minutes) of the commercial resins, with our illustrative isothermal rapid cure resins for aerospace applications are shown in Table 1.

TABLE 1

| | Infusion | Cure | Cure |
|---|---|---|---|
| | Temperature | Temperature | Time |
| Resin | (° C.) | (° C.) | (minutes) |
| Hexcel RTM-6 | 120 | 180 | 90 |
| HiFlow 1078-1 | 120 | 180 | 120 |
| Solvay CYCOM 890 RTM | 180 | 180 | 120 |
| Solvay PRISM EP2410 | 120 | 180 | 120 |
| Toray RS-50 | 121 | 177 | 120 |
| Isothermal Rapid Cure | ~80-97 | ~80-97 | 60 |
| of Present Invention | | | |

As apparent from the summary presented in Table 1, the isothermal rapid cure resins according to the present invention are processed isothermally at substantially lower temperatures for substantially less time.

Generalized characteristic differences between isothermal rapid cure resins according to aspects of the present invention as compared with a commercial resin are shown in Table 2.

TABLE 2

| | Isothermal Rapid | |
|---|---|---|
| | Cure Resin of | |
| Characteristic | Present Invention | Commercial Resin |
| Processing/ | Infusion and | Infusion temperature is much |
| Preparation | cure at same | lower than cure temperature. |
| | temperature | After infusion, the tooling is |
| | | heated to the higher cure |
| | | temperature. |
| Total Infusion and | Completed within | Completed in approx. 2.8 |
| Cure Time | one (1) hour | hours. |
| Infusion Temp. | ~80° C. to 97° C. | 120° C. to 180°C |
| Cure Temp. | ~80° C. to 97° C. | ~180° C. |
| Temperature at which | ~80° C. to 97° C. | 180° C. |
| composite part may | | |
| be removed from tool | | |
| without deforming. | | |
| Tooling ready for | Within one | ~2.8 hours + tool cooling |
| next infusion. | (1) hour | time |

We note that while some commercial resins such as CYCOM® 890 RTM do provide isothermal infusion and cure temperatures, albeit ^{˜}100° C. higher than resins according to the present invention, the cure time is 2× that of the resins according to the present invention.

As previously noted, our inventive formulations solve problems plaguing the art and may be generally classified into one of four types namely: Type-1 anionic formulations; Type-2 anionic formulations; toughened Type-2 anionic formulations; and cationic formulations.

Depending upon the specific formulation and as will be described in much greater detail and specificity, our inventive resins may include epoxies, hardeners, catalysts, tougheners, and antioxidants.

### Experimental Approach

### Resin Formulation

Resin formulations were prepared and characterized to determine if they exhibit isothermal infusion and cure temperature requirements suitable for aerospace application. Characterization of the resin formulations included differential scanning calorimetry (DSC) to determine glass transition temperature (T_{g}), cure behavior, and post cure conditions, rheology to determine viscosity as a function of temperature, and dynamic mechanical analysis (DMA) to determine T_{g} from loss modulus, tan delta, and storage modulus curves and storage modulus at 25° C. values. Resin formulations that exhibited suitable T_{g} and isothermal processing parameters were further scaled to generate sufficient material for composite fabrication.

### Cure Characterization

Cure characterization was determined by DSC (TA Instruments DSC 25) in which several milligrams of uncured resin was evaluated. Characterization was conducted under a nitrogen atmosphere and temperature was scanned from 30° C. to 250° C. at ramp rates of 5° C./min and 20° C./minute to evaluate the cure exotherm and dry T_{g} of the resin, respectively. Post cure conditions were determined on several milligrams of resin by first isothermally curing at ˜80° C. to 97° C. for one (1) hour followed by cooling to 25° C. and then heating to elevated temperature (i.e., greater than the cure temperature) and holding for a specific amount of time to control any residual exothermic reaction.

### Viscosity Characterization

Complex viscosity characterization was determined on ^{˜}0.8 mL of resin by rheology (TA Instruments, ARS rheometer) using a frequency of 12.5 rad/s, a strain of 5.0%, and temperature ramp rate of 5° C./min. The temperature was increased to the isothermal infusion/cure temperature and held for up to two (2) hours. Resin cure began when the complex viscosity was greater than 1000 cps. Gelation was determined as the crossover point of the storage (G′) and loss (G″) moduli.

Brookfield viscosity was determined using a Brookfield DV2T viscometer outfitted with an enhanced UL adapter.

### Composite Processing

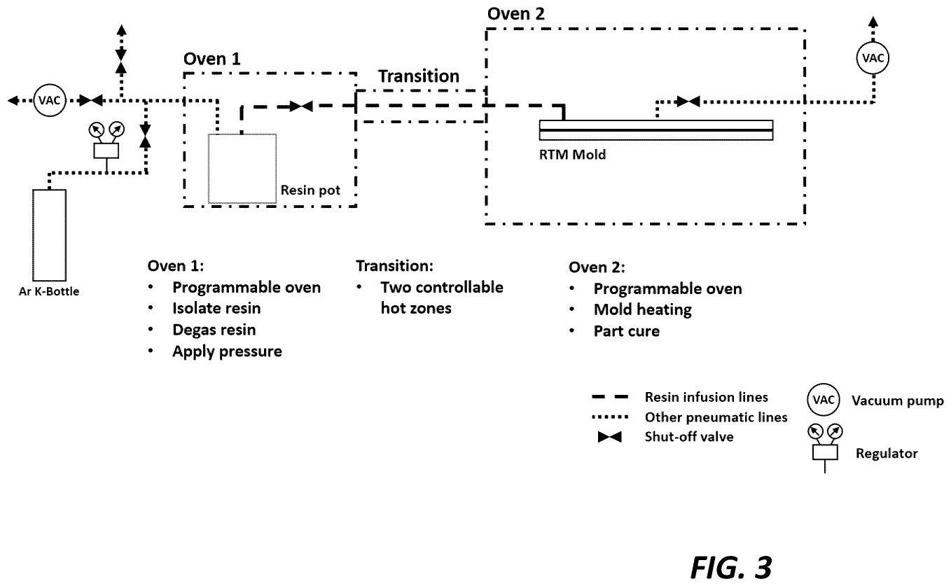

FIG. 3 is a schematic diagram showing an illustrative arrangement for composite processing according to aspects of the present invention. As illustratively shown in that figure, a pair of ovens are provided in series in which a first oven (Oven 1) includes a resin pot while a second oven (Oven 2) includes a resin transfer molding (RTM) mold that is evacuated by a vacuum source. The two ovens are in fluidic communication by transition piping, which in our illustrative arrangement includes two controllable hot zones.

Operationally, resin was introduced into Oven 1 for degassing and heating to an infusion temperature. The RTM tool (mold) was positioned in Oven 2, which was set to the infusion temperature. Initial evaluation composites were formed in the RTM mold sized to produce 15.24 cm×15.24 cm (6″×6″) composite panels.

Evaluation composite panels were fabricated using Saertex® non-crimp, quasi-isotropic fabric with a symmetric schedule. Four (4) layers and eight (8) layers of fabric were used for 2.25 mm and 4.5 mm thick panels, respectively.

Resin in the resin pot in Oven 1 was heated to the infusion temperature and subsequently pressurized to the infusion pressure and urged into the RTM mold. A timer for the process was initiated when a resin valve was opened, permitting infusion temperature resin to flow into the mold. Infusion was continued until resin was visible in an outlet of the mold with little or no bubbling indicating that all gas is substantially removed from the mold and its volume replaced by the resin/composite. Note that once infusion is complete, pressure may be adjusted for curing. The mold is then isolated from vacuum and pressure sources for the remainder of the in-mold curing cycle.

Total time from initiating resin infusion to demolding of the composite part was one (1) hour. Upon the expiration of the hour, the mold—including the composite part—was removed from the oven and the composite panel was immediately demolded (removed from the mold). To ensure that no deformation occurred during a free-standing post cure cycle, an 0.8 kg (1.8 lb.) or ^{˜}3 kg (6.6 lb.) weight was set on the simply supported 2.25 mm (0.09″) or 4.5 mm (0.18″) thick composite panel respectively.

### Performance Testing

### Thermal ANALYSIS

A composite property target was for a wet T_{g} of ≥149° C. (300° F.). The dry T_{g} of neat resin specimens (15-20 mm×3 mm×1 mm, L×W×T) were first evaluated as a screening for meeting this requirement. According to ASTM E1640, resin specimens were heated at a rate of 1° C./min from room temperature (RT) to 300° C. A method prescribed by ASTM D5229, Procedure B indicates a method for conditioning wet T_{g} specimens. According to that standard, samples were soaked in water at 70° C. until the mass of the sample reached equilibrium (˜2 weeks), then loaded into a Dynamic Mechanical Analyzer (DMA) and analyzed at 5° C./min.

### Mechanical Testing

Composite panels produced were tested for tensile, toughness, and compression properties. Tests employed included the following: Tensile-ASTM D3039; Non-pre-cracked End Notched Fracture Toughness-ASTM D7905; and Combined Load Compression-ASTM D6641.

### Specific Embodiments

The following examples are presented to illustrate the invention and are not intended to limit the scope of the claims. Unless otherwise stated, all parts and percentages are by weight.

### Type-1 Anionic Formulations

Anionic formulations are one type of epoxy curing system that utilizes negatively charged ions to initiate the curing process. As used herein, Type 1 epoxies are pre-mixed with a curing agent. This eliminates the need for mixing ratios and simplifies application. Anionic catalysts trigger a reaction with the epoxy resin, promoting crosslinking and hardening.

Type-1 anionic formulations evaluated include the following resin characteristics shown in Table 3.

TABLE 3
1-Part Anionic Resin Characteristics

| Formulation Ranges (wt. %) | BADGE 1075; 0-99 |
|---|---|
| | BADGE 377: 0-99. |
| | TGMDA: 0-99 |
| | DGOA: 0-99 |
| | Catalyst: 1-2 |
| Infusion/Cure Temperature ° C. | 76-90 |
| Time to Gel as function of formulation | 18-55 |
| and infusion/cure temperatures (min.) | |
| Storage Modulus Onset T_{g} (° C.), DMA | 116-191 |
| Storage Modulus, E′ (GPa) at 25° C., DMA | ~2.7-3.3 |

Epoxies used in the formulation of our inventive Type-1 anionic formulations—except for the BADGE 1075—and the catalyst are all liquids at RT. We note that the catalyst is a liquid at RT after being melted at 100° C., and then cooled to RT. The epoxies are all combined and mixed at RT for ^{˜}15 minutes and the catalyst is added prior to resin use. Mixing the catalyst into the epoxy mixture is performed at RT for ^{˜}15 minutes. The resin-catalyst mixture is then degassed at temperatures ranging from 50° C. to 70° C. under vacuum.

For small batches used for characterization, the resin and the catalyst are combined and mixed at RT for ˜5 minutes at RT prior to conducting the rheology tests. The resin/catalyst mixture is then degassed at 50° C. to 70° C. prior to DMA and dog bone sample generation. Those skilled in the art will understand and appreciate that dog bone samples are a type of material sample that are primarily used in tensile tests. Dog bone samples have a shoulder at each end and a gauge section in between. The shoulders are wider than the gauge section which causes a stress concentration to occur in the middle when the sample is loaded with a tensile force.

A number of curable isothermal epoxy formulations were prepared with each containing a number of components selected from Bisphenol A Diglycidyl Ether—(BADGE)), Poly(Bisphenol A-co-epichlorohydrin), glycidyl end-capped-average molecular weight (Avg. MW) 1075—(BADGE 1075), Poly(Bisphenol A-co-epichlorohydrin), glycidyl end-capped—Avg. MW 377—(BADGE 377), Tetraglycidyl methylene dianiline (TGMDA), N,N-diglycidyl-4-glycidyloxyaniline (DGOA), and 2-ethyl-4-methylimidazole (2Et4Melm).

### Example 1

An isothermal curable epoxy Type-1 formulation according to the present invention is prepared according to the composition shown in Table 4.

TABLE 4
FORMULATION

| BADGE 377 (%) | TGMDA (%) | DGOA (%) | 2Et4Melm (%) |
|---|---|---|---|
| 24 | 74 | 0 | 2 |

### Example 2

A Type-1 isothermal curable epoxy formulation according to the present invention is prepared according to the composition shown in Table 5.

TABLE 5
FORMULATION

| BADGE (%) | TGMDA (%) | DGOA (%) | 2Et4Melm (%) |
|---|---|---|---|
| 23.3 | 35.3 | 39.3 | 2 |

### Type-2 Anionic Formulations

A Type-2 anionic formulation is a multi-component system that includes a separate curing agent (resin and hardener).

Type-2 anionic formulations according to aspects of the presentation include the following resin characteristics shown in Table 6.

TABLE 6
Type-2 Anionic Resin Characteristics

| Formulation Ranges (wt. %) | BADGE 1075: 0-8 |
|---|---|
| | TGMDA: 12-42 |
| | DGOA: 33-77 |
| | mPDA: 8-12 |
| | 4,4′DDS: 8-16 |
| | Catalyst: 0-1 |
| Infusion/Cure Temperature ° C. | 70-94 |
| Time to Gel as function of formulation | 17-95 |
| and infusion/cure temperatures (min.) | |
| Storage Modulus Onset T_{g}s (° C.), DMA | 118-242 |
| Storage Modulus, E′ (GPa) at 25° C., DMA | ~3.2-4.2 |

Epoxies used in the formulation of our inventive Type-2 anionic formulations—except for BADGE 1075—and the catalyst are all liquids at RT. As previously noted, the catalyst is a liquid at RT after being melted at 100° C., and then cooled to RT. Type-2 anionic formulation epoxies—in addition to those shown illustratively in Table 6 may include Poly(ethylene glycol) diglycidyl ether, Poly(propylene glycol) diglycidyl ether, Neopentyl Glycol Diglycidyl Ether, and 3-Ethyl-3-oxetanemethanol.

Diamine components including meta-Phenylenediamine (mPDA) and 4,4′-Diaminodiphenylsulfone (4,4′DDS) are solids. Other diamines that may be employed with our Type-2 anionic formulations may include polyetheramines such as Jeffamine® D230 which is a liquid. Other diamines that may be employed in our inventive Type-2 anionic formulations according to the present invention include 3,4′-oxydianiline, N-phenyl-p-phenylene diamine, and 1,3-bis(4-aminophenoxy) benzene. The diamine components are mixed with the catalyst (2Et4Melm), and the entire mix is melted to form a liquid by immersion in a hot oil bath set—for example—at ^{˜}200° C. to 210° C. Once melted, the liquid is allowed to cool to RT.

The epoxies are added to the diamine/catalyst liquid once it has cooled to RT. We note that the liquid diamine/catalyst exhibits sufficient stability such that it may be used after more than one day. Once the epoxies and liquid diamine/catalyst are mixed, the mixture is stirred at RT for a minimum of 5 minutes for small batches (^{˜}10 g) or ^{˜}15 minutes for larger batches used to make composites.

Resin degassing is performed at temperatures of 35° C. to 40° C. under vacuum. For rheology characterization the mixture is evaluated after mixing. Prior to generating DMA and dog bone samples, the resin mixture is degassed.

Several curable isothermal 2-Part epoxy formulations were prepared with each containing several components selected from TGMDA, DGOA, mPDA, 4,4′DDS, and 2Et4Melm.

### Example 3

An isothermal curable epoxy Type-2 formulation according to the present invention is prepared according to the composition shown in Table 7.

TABLE 7
FORMULATION

| TGMDA | DGOA | mPDA | 4,4′DDS | 2Et4Melm |
|---|---|---|---|---|
| (wt %) | (wt %) | (wt %) | (wt %) | (wt %) |
| 39.45 | 37.55 | 11.15 | 10.95 | 1 |

### Example 4

An isothermal curable epoxy Type-2 formulation according to the present invention is prepared according to the composition shown in Table 8.

TABLE 8
FORMULATION

| TGMDA | DGOA | mPDA | 4,4′DDS | 2Et4Melm |
|---|---|---|---|---|
| (wt %) | (wt %) | (wt %) | (wt %) | (wt %) |
| 19.06 | 57.56 | 11.26 | 11.16 | 0.96 |

### Example 5

An isothermal curable epoxy Type-2 formulation according to the present invention is prepared according to the composition shown in Table 9.

TABLE 9
FORMULATION

| TGMDA | DGOA | mPDA | 4,4′DDS | 2Et4Melm |
|---|---|---|---|---|
| (wt %) | (wt %) | (wt %) | (wt %) | (wt %) |
| 29.67 | 47.17 | 11.17 | 10.97 | 0.92 |

### Example 6

An isothermal curable epoxy Type-2 formulation according to the present invention is prepared according to the composition shown in Table 10.

TABLE 10
FORMULATION

| | BADGE | | | | |
|---|---|---|---|---|---|
| TGMDA | 1075 | DGOA | mPDA | 4,4′DDS | 2Et4Melm |
| (wt %) | (wt %) | (wt %) | (wt %) | (wt %) | (wt %) |
| 29.67 | 7.3 | 47.17 | 11.17 | 10.97 | 0.92 |

### Example 7

A toughened, isothermal curable epoxy Type-2 formulation according to the present invention is prepared according to the composition shown in Table 11. Note that the toughener employed is Ethacure® 420 (4,4″-methylenebis[N-sec-butylaniline]) curative, a curing agent and chain extender.

TABLE 11
FORMULATION

| | | | | Ethacure | |
|---|---|---|---|---|---|
| TGMDA | DGOA | mPDA | 4,4′DDS | 420 | 2Et4Melm |
| (wt %) | (wt %) | (wt %) | (wt %) | (wt %) | (wt %) |
| 38.2 | 36.3 | 10.4 | 9.7 | 4.3 | 1.00 |

### Cationic Formulations

Cationic formulations according to aspects of the present invention include epoxy, catalyst, and antioxidant.

Cationic formulations according to aspects of the invention include the following resin characteristics shown in Table 12. The eq. stands for equivalents to epoxy groups.

TABLE 12
Cationic Resin Characteristics

| Formulation Ranges (wt. %) | BADGE: 0-100 |
|---|---|
| | BADGE 1075: 0-10 |
| | BADGE 377: 0-1 |
| | Phenolic 570: 0-66.5 |
| | Phenolic 345: 0-50 |
| | EOM: 0-100 |
| | Eponex ™ 1510: 0-30 |
| | Tris 4-HMTE: 0-33.32 |
| | Catalyst: 0-1 |
| Catalyst | TPED (eq.) 0-0.01 |
| | IOC8 (eq.) 0-0.015 |
| Antioxidant | BHT (wt %) 0-0.5 |
| Infusion/Cure Temperature ° C. | 85-100 |
| Time to Gel as function of formulation | 5-40 |
| and infusion/cure temperatures (min.) | |
| Storage Modulus Onset T_{g}s (° C.), DMA | 85-160 |
| Storage Modulus, E′ (GPa), DMA | ~2.9-4.6 |

(eq.)—Equivalents

Cationic formulations according to aspects of the presentation may include combinations of the following epoxies Bisphenol A Diglycidyl Ether (BADGE), Poly(Bisphenol A-co-epichlorohydrin), glycidyl end-capped—Avg. MW 1075 (BADGE 1075), Poly(Bisphenol A-co-epichlorohydrin), glycidyl end-capped—Avg. MW 377 (BADGE 377), Poly[(phenyl glycidyl ether)-co-formaldehyde]Avg. MW 570 (Phenolic 570), Poly[(phenyl glycidyl ether)-co-formaldehyde)—Avg. MW 345 (Phenolic 345), 3-Ethyl-3-oxetanemethanol (EOM), Eponex™ 1510, Tris(4-hydroxyphenyl) methane triglycidyl ether (Tris4-HMTE), 3,4-Epoxycyclohexylmethyl-3,4-epoxycyclohexanecarboxylate, Neopentyl Glycol Diglycidyl Ether; catalysts including 1, 1, 2, 2-Tetraphenyl-1,2-ethanediol (TPED) and p-(Octyloxyphenyl)phenyliodonium Hexafluoroantimonate (IOC8), and antioxidant Butylated Hydroxytoluene (BHT).

The preparation of cationic formulations according to the present invention involve: adding epoxies to a reaction vessel, placing reaction vessel in a water bath (70° C.) and stirring until all components are melted and combined (^{˜}1 hour). Solid TPED is ground to decrease the particle size then added with the remaining initiating system to the reaction vessel. The vessel is placed in an approximate 50° C. water bath and stirred until homogeneous (overnight).

### Example 8

A cationic, isothermal curable epoxy formulation according to the present invention is prepared according to the composition shown in Table 13.

TABLE 13
FORMULATION

| | | | | | TPED | IOCB | |
|---|---|---|---|---|---|---|---|
| | BADGE | PHENOLIC | | Tris4- | (eq. to | (eq. to | |
| BADGE | 377 | 570 | EOM | HMTE | epoxy | epoxy | BHT |
| (%) | (%) | (%) | (%) | (%) | groups) | groups) | (%) |
| 68.98 | 0.98 | 9.98 | 19.98 | 9.98 | 0.01 | 0.01 | 0.1 |

As noted previously, composite panels of several formulations were prepared, and their mechanical properties evaluated. Mechanical properties for a composite panel constructed from a representative Type-1 anionic formulation according to the present invention are shown in Table 14.

TABLE 14
COMPOSITE MECHANICAL PROPERTIES—
REPRESENTATIVE TYPE-1 ANIONIC FORMULATION

| Tensile | Tensile | Compressive | End Notch |
|---|---|---|---|
| Strength | Modulus | Strength | Fracture |
| (MPa) | (GPa) | (MPa) | Toughness, (G_{IIC}) |
| 565 ± 15 | 60 ± 4 | 323.7 ± 17.6 | 0.62 |

Mechanical properties for a composite panel constructed from a representative Type-2 anionic formulation according to the present invention are shown in Table 15.

TABLE 15
COMPOSITE MECHANICAL PROPERTIES—
REPRESENTATIVE TYPE-2 ANIONIC FORMULATION

| Tensile | Tensile | Compressive | |
|---|---|---|---|
| Strength | Modulus | Strength | End Notch Fracture |
| (MPa) | (GPa) | (MPa) | Toughness, (G_{IIC}) |
| 681 ± 18 | 65 ± 1 | 412.6 ± 18.2 | 0.93 ± 0.08 |

Mechanical properties for a composite panel constructed from a representative cationic formulation according to the present invention are shown in Table 16.

TABLE 16
COMPOSITE MECHANICAL PROPERTIES—
REPRESENTATIVE CATIONIC FORMULATION

| Tensile | Tensile | Compressive | |
|---|---|---|---|
| Strength | Modulus | Strength | End Notch Fracture |
| (MPa) | (GPa) | (MPa) | Toughness, (G_{IIC}) |
| 658 ± 7 | 64 ± 1.6 | — | — |

While the present invention has been described with reference to embodiments thereof, it will be understood that numerous modifications may be made by those skilled in the art without actually departing from the spirit and scope of the invention as defined in the appended claims. For example, while we have described our inventive formulations in the context of infusion processes, our formulations are not so limited.

As those skilled in the art will readily appreciate, our inventive formulations according to aspects of the present invention may advantageously be employed to produce prepreg composites that are made of reinforcing fibers/fabrics pre-impregnated with partially cured resin. Additionally, both prepreg and infusion techniques in conjunction with the formulations according to the present invention may be employed to produce composite materials including carbon fiber, fiberglass, aramid (Kevlar®) fibers, basalt fibers, natural fibers including hemp, flax, etc., ceramic fibers, inorganic fibers (i.e., boron), other known reinforcement fibers or filler material including graphene, nanotubes, and hybrid composites including two or more known composite fiber materials. Accordingly, this disclosure and our inventions should only be limited by the scope of the claims attached hereto.

1. A composite material including an epoxy resin formulation comprising 23 to 24 weight % bisphenol-A diglycidyl ether (BADGE), 35 to 75 weight % tetraglycidyl methylene dianiline (TGMDA), 0 to 40 weight % N,N,diglycidyloxyanile (DGOA) and 2 weight % 2-ethyl-4-methyl-imidazole (2Et4Melm), the composite material formed via an isothermal infusion and cure process in which infusion and cure temperatures of the epoxy resin are about the same, are less than about 100° C., and cure time is less than about one hour.

2. The composite material of claim 1 including one or more composite fiber materials selected from the group consisting of carbon fibers, aramid fibers, glass fibers, basalt fibers, natural fibers, ceramic fibers, inorganic fibers including boron, and graphene.

3. The composite material of claim 2 in which the epoxy resin comprises about 23 weight % BADGE, about 35 weight % TGMDA, about 2 weight % 2Et4Melm and about 39 weight % DGOA.

4. The composite material of claim 2 in which the epoxy resin comprises about 24 weight % BADGE having a molecular weight of 377 (BADGE 377), about 74 weight % TGMDA, about 0 weight % DGOA, and about 2 weight % 2Et4Melm.

5. A composite material including an epoxy resin formulation comprising 12 to 42 weight % tetraglycidyl methylene dianiline (TGMDA), 33 to 77 weight % N,N,-diglycidyl-4-glycidyloxyanile (DGOA), 8 to 12 weight % m-phenylene diamine (mPDA), 8 to 16 weight % 4,4′-Diaminodiphenyl sulfone (4,4′DDS) and 0.1 to 1 weight % 2-ethyl-4-methyl-imidazole (2Et4Melm), the composite material formed via an isothermal infusion and cure process in which infusion and cure temperatures of the epoxy resin are about the same, are less than about 100° C., and cure time is less than about one hour.

6. The composite material of claim 5 including one or more composite fiber materials selected from the group consisting of carbon fibers, aramid fibers, glass fibers, basalt fibers, natural fibers, ceramic fibers, inorganic fibers including boron, and graphene.

7. The composite material of claim 5 in which the epoxy resin comprises about 39 weight % TGMDA, about 37 weight % DGOA, about 11 weight % mPDA, about 10 weight % 4-4′-DDS, and about 1 weight % 2Et4Melm.

8. The composite material of claim 5 in which the epoxy resin comprises about 19 weight % TGMDA, about 77 weight % DGOA, about 11 weight % mPDA, about 11 weight % 4-4′-DDS, and about 1 weight % 2Et4Melm.

9. The composite material of claim 5 in which the epoxy resin comprises about 29 weight % TGMDA, about 47 weight % DGOA, about 11 weight % mPDA, about 10 weight % 4-4′-DDS, and about 0.9 weight % 2Et4Melm.

10. The composite material of claim 5 in which the epoxy resin further comprises 1 to 10 weight % bisphenol-A diglycidyl ether (BADGE).

11. The composite material of claim 5 in which the epoxy resin comprises about 29 weight % TGMDA, about 7 weight % BADGE having a molecular weight of 1075 (BADGE 1075), about 47 weight % DGOA, about 11 weight % mPDA, about 11 weight % 4-4′-DDS, and about 0.9 weight % 2Et4Melm.

12. The composite material of claim 5 further comprising about 4 weight % Ethacure® 420 curative.

13. A composite material including an epoxy resin formulation comprising about 69 weight % Bisphenol A Diglycidyl Ether (BADGE), about 1.0 weight % Poly(Bisphenol A-co-epichlorohydrin), glycidyl end-capped (BADGE 377—Avg. MW 377), about 10 weight % Poly[(phenyl glycidyl ether)-co-formaldehyde] (Phenolic 570—Avg. MW 570), about 20 weight % 3-Ethyl-3oxetanemethanol (EOM), about 10 weight % Tris(4-hydroxyphenyl) methane triglycidyl ether (Tris4-HMTE), about 0.01 eq. to epoxy groups 1,1,2,2-Tetraphenyl-1,2-ethanediol (TPED), about 0.01 eq. to epoxy groups p-(Octyloxyphenyl)phenyliodonium Hexafluoroantimonate (IOC8), and about 0.1 weight % Butylated hydroxytoluene (BHT), the composite material formed via an isothermal infusion and cure process in which infusion and cure temperatures of the epoxy resin are about the same, are less than about 100° C., and cure time is less than about one hour.

14. The composite material of claim 13 including one or more composite fiber materials selected from the group consisting of carbon fibers, aramid fibers, and glass fibers, basalt fibers, natural fibers, ceramic fibers, inorganic fibers including boron, and graphene.

15. A composite material including the epoxy formulation of claim 1 formed via an isothermal prepreg process in which impregnation and cure temperatures of the epoxy resin are the same, less than about 100° C., and cure time is less than about one hour.

16. A composite material including the epoxy formulation of claim 5 formed via an isothermal prepreg process in which impregnation and cure temperatures of the epoxy resin are less than 100° C. and cure time is less than one hour.

17. A composite material including the epoxy formulation of claim 13 formed via an isothermal prepreg process in which impregnation and cure temperatures of the epoxy resin are less than 100° C. and cure time is less than one hour.

18. The composite material according to claim 1 having a glass transition temperature (T_{g})≥150° C. and a storage modulus ≥3 GPa.

19. The composite material according to claim 5 having a glass transition temperature (T_{g})≥150° C. and a storage modulus ≥3 GPa.

20. The composite material according to claim 13 having a glass transition temperature (T_{g})≥150° C. and a storage modulus ≥3 GPa.
